(19) United States
(12) Patent Application Publication
(10) Pub. No.: US 2016/0003200 A1
(43) Pub. Date: Jan. 7, 2016

(54) DISPOSABLE FILTER FOR AN ENGINE

(71) Applicant: CATERPILLAR INC., PEORIA, IL (US)

(72) Inventor: Bobby J. Kinsey, JR., Washington, IL (US)

(21) Appl. No.: 14/321,142

(22) Filed: Jul. 1, 2014

(51) Int. Cl. F02M 35/024; B01D 46/00; B01D 46/52

(52) U.S. Cl. CPC F02M 35/02416; B01D 46/521; B01D 46/0015

(57) ABSTRACT

A disposable filter for an engine includes a shroud and a filter element. The shroud has at least one pair of sidewalls that define an inlet and an outlet respectively therethrough. The sidewall includes an outer ply, an inner ply, and a core comprising a honeycomb matrix of cells. The outer ply and the inner ply are disposed in a spaced-apart relation to each other. Lateral ends of the core are bonded to inner surfaces of the outer ply and the inner ply to integrally form the sidewall. The filter element is disposed within the shroud and also releasably coupled to the shroud. Further, the shroud and the filter element are both formed using at least one bio-degradable material.

### TECHNICAL FIELD

The present disclosure generally relates to an air filter. More particularly, the present disclosure relates to a low-cost, disposable air filter that is substantially bio-degradable.

### BACKGROUND

Engines are typically provided with air filters to filter air that is supplied for combustion of fuel. A conventional air filter may include a filter element and a housing besides other hardware. The filter element may be disposed within the housing and may be configured to separate dust, dirt and other particles from the inlet air. In most cases, the housing, the filter element, and/or other components of the air filter may be constructed from plastics, metals, or other non-biodegradable materials.

For reference, PCT Publication No. 1992/009766 relates to a filter that is formed from synthetic plastics or metals. However, the non-biodegradability factor, inherent with the type of material used in the construction of the air filter, may pose various environmental concerns. Moreover, a cost of manufacturing the conventional air filters may be high with use of plastics, and/or metals. With high manufacturing costs, retail cost of the conventional air filters may increase.

Hence, there exists a need for an air filter that overcomes the above mentioned drawbacks.

### SUMMARY OF THE DISCLOSURE

In one aspect of the present disclosure, a disposable filter for an engine includes a shroud and a filter element. The shroud has at least one pair of sidewalls that define an inlet and an outlet respectively therethrough. The sidewalls of the shroud include an outer ply, an inner ply, and a core comprising a honeycomb matrix of cells. The outer ply and the inner ply are disposed in a spaced-apart relation to each other. Lateral ends of the core are bonded to inner surfaces of the outer ply and the inner ply to integrally form the sidewall. The filter element is disposed within the shroud and releasably coupled to the shroud. Further, the shroud and the filter element are both formed using at least one bio-degradable material.

Other features and aspects of this disclosure will be apparent from the following description and the accompanying drawings.

### BRIEF DESCRIPTION OF THE DRAWINGS

FIG. 1 is a perspective view of a filter showing a shroud of the filter, in accordance with an embodiment of the present disclosure, that can be used in an engine;

FIG. 2 is a tear-away view of a sidewall of the shroud;

FIG. 3 is a front sectional view of the filter showing a first engagement member and a second engagement member; and

FIG. 4 is an exploded view of the filter showing a filter element and the shroud.

### DETAILED DESCRIPTION

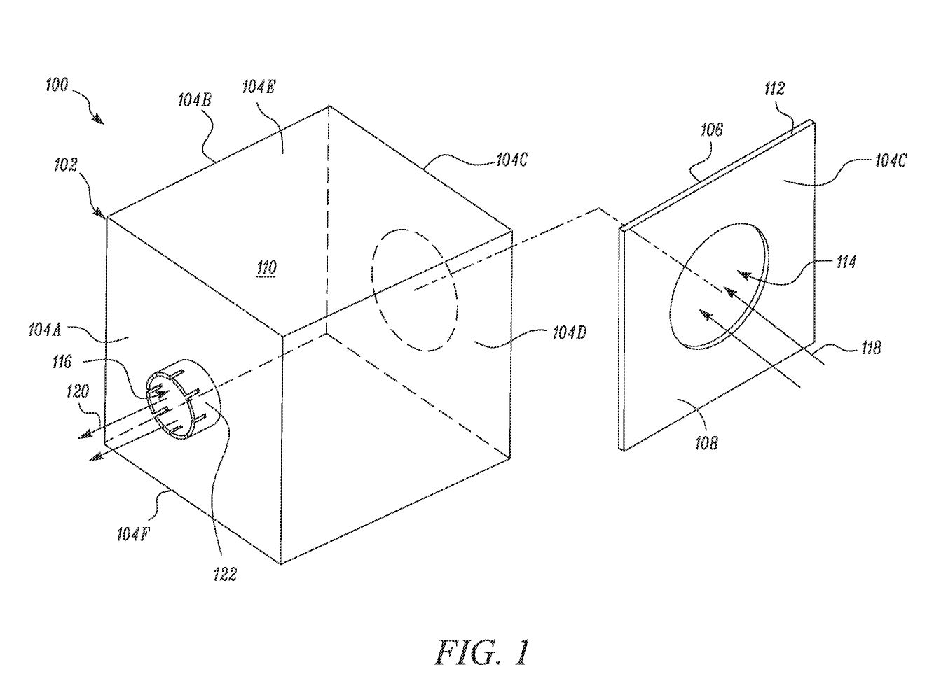

The present disclosure generally relates to an air filter. More particularly, the present disclosure relates a disposable air filter that is substantially bio-degradable and hence, may be incinerated. FIG. 1 illustrates a filter 100 in accordance with an embodiment of the present disclosure. The filter 100 may be employed in an engine (not shown), for e.g., an internal combustion engine, to filter air that is supplied for combustion of fuel. The filter 100 may be in fluid communication with an air intake system (not shown) associated with the engine and configured to supply the filtered air. Alternatively, the filter 100 may be used to filter air that is provided for a pneumatic pump or actuator, a cooling system, or other systems known in the art.

Referring to FIG. 1, the filter 100 includes a shroud 102 that is made of one or more bio-degradable materials. The shroud 102 may have one or more pairs of sidewalls 104. In the illustrated embodiment, the shroud 102 has a rectangular box-type structure and thus, includes six sidewalls 104 (104A, 104B, 104C, 104D, 104E, 104F). Alternatively, the shroud 102 may embody other structures and/or shapes such as, but not limited to, planar, curvilinear, spherical, frusto-conical, conical, annular, asymmetrical and the like as will be explained hereinafter.

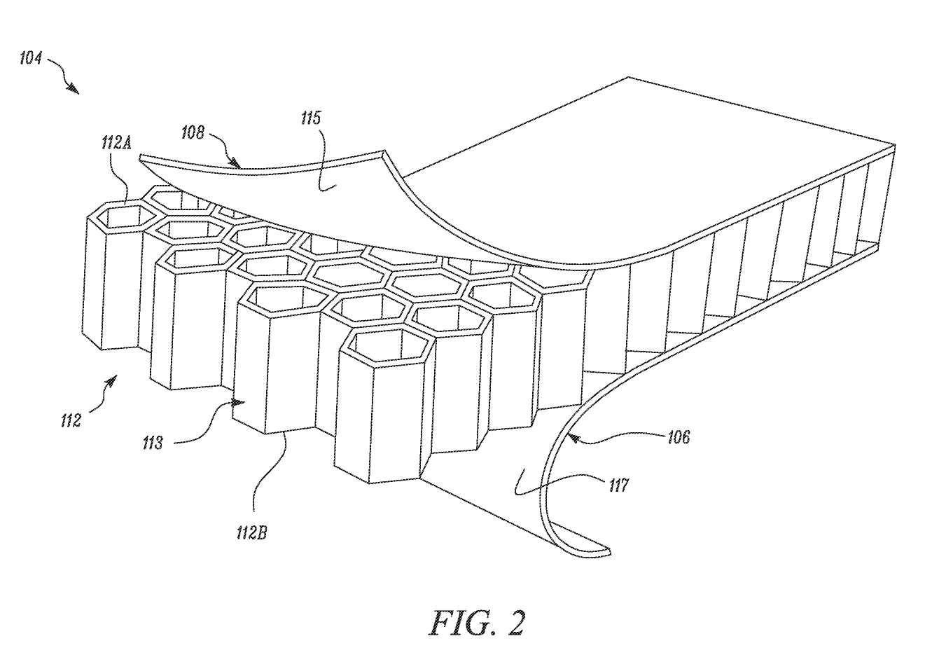

Referring to FIGS. 1 and 2, the sidewall 104 includes an inner ply 106 and an outer ply 108 that are spaced apart from each other. The inner plies 106 corresponding to all the sidewalls 104 together provide an interior volume 110 of the shroud 102. The inner ply 106 and the outer ply 108 are made of one or more bio-degradable materials. For example, the inner ply 106 and the outer ply 108 may be made from paper. In an embodiment, at least one of the inner ply 106 and the outer ply 108 are resin-impregnated plies. Optionally, the inner ply 106 and the outer ply 108 may be individually made from different materials and/or different thickness to impart varying properties to the respective sidewall 104.

As shown in FIG. 2, a core 112 is disposed in between the inner ply 106 and the outer ply 108. The core 112 is formed from a honeycomb matrix of cells 113. The honeycomb matrix 113 is made from one or more bio-degradable materials such as, but not limited to, paper, cardboard and the like by methods commonly known to one skilled in the art.

The core 112 is bonded between the inner ply 106 and the outer ply 108 to integrally form the corresponding sidewall 104. A lateral end 112A of the core 112 is bonded to an inner surface 115 of the outer ply 108 while another lateral end 112B is bonded to an inner surface 117 of the inner ply 106. The bonding of the core 112 to the inner and outer plies 106, 108 may be accomplished using suitable types of adhesives for e.g., resins based adhesives, epoxy based adhesives, or any other adhesives known in the art.

Although, one outer ply 108 and one inner ply 106 are shown bonded to the core 112, it may be contemplated to beneficially include more than two plies to increase stiffness of the corresponding sidewall 104.

Further, ends of adjacent sidewalls 104 may be coupled to each other to integrally form the shroud 102. The coupling may be accomplished by way of mechanical fastening, adhesive bonding, or other suitable methods known in the art.

In an embodiment, one or more sidewalls 104A, 104B, 104C, 104D, 104E, 104F of the shroud 102 may be coated with a hydrophilic substance for e.g., urethane. The hydrophilic substance may prevent wetting of the shroud 102, when exposed to fluids. Further, the hydrophilic substance may improve structural integrity of the shroud 102.

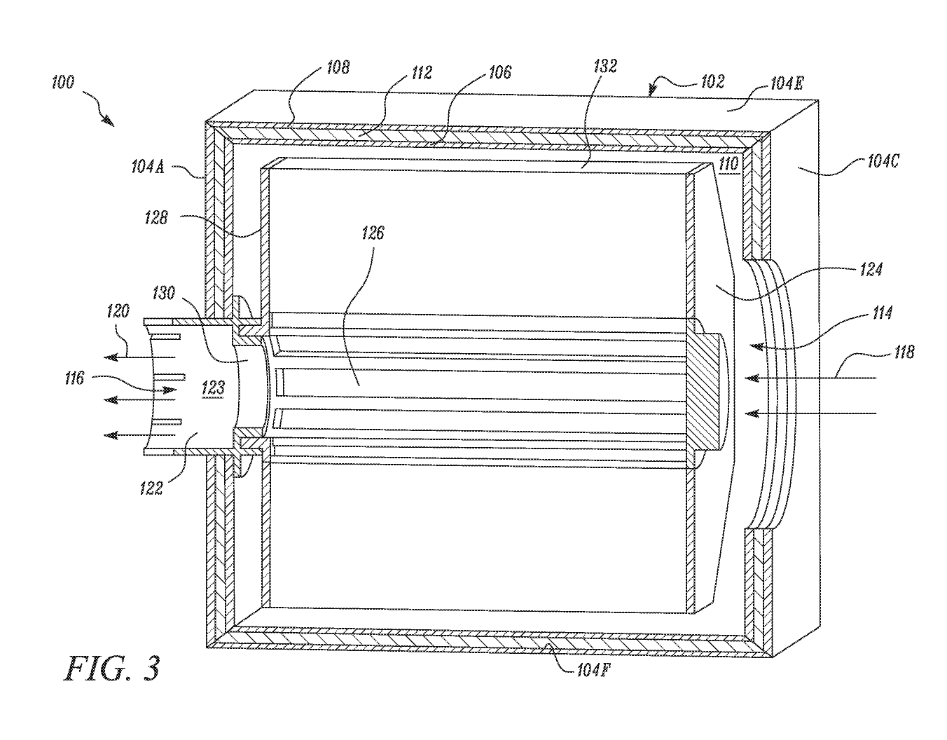

Referring to FIGS. 1 and 3, the shroud 102 defines an inlet 114 and an outlet 116. In the illustrated embodiment of FIG. 1, the inlet is defined by the sidewall 104C while the outlet is defined by the sidewall 104A. However, a person of ordinary skill in the art will acknowledge that any of the sidewalls 104A, 104B, 104C, 104D may define one or more inlets 114 and the outlets 116. The inlet 114 is configured to provide a passage for an inlet air flow 118 into the shroud 102. The outlet 116 is configured to provide a passage for an outlet air flow 120.

Further, a first engagement member 122 may be disposed in the outlet 116. The first engagement member 122 may have a tube-like structure that defines a passage 123 for the outlet air flow 120 out of the shroud 102. Moreover, the first engagement member 122 may be sealed across the outlet 116 to prevent leakage of air between the outlet 116 and the first engagement member 122. The first engagement member 122 may be coupled to the air intake system of the engine.

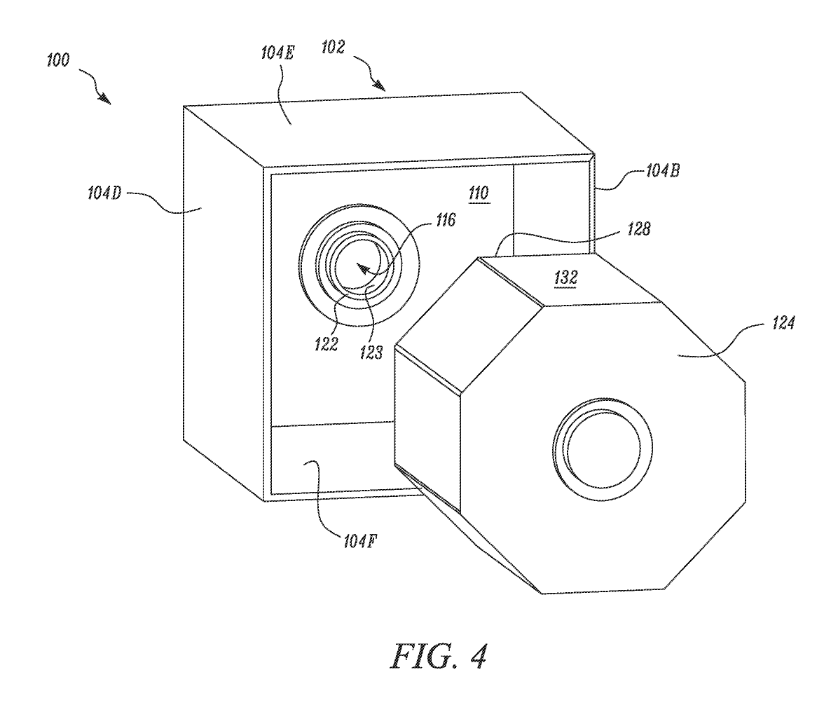

Referring to FIG. 4, the filter 100 further includes a filter element 124 that is releasably coupled with the shroud 102. The filter element 124 may define a channel 126 as shown in FIG. 3. The channel 126 extends towards an end 128 of the filter element 124. The filter element 124 may be disposed with in the interior volume 110 of the shroud 102 such that the channel 126 axially aligns with the outlet 116 of the shroud 102.

Referring to FIG. 3, a second engagement member 130 may be disposed in the channel 126 adjacent to the end 128 of the filter element 124. Further, the second engagement member 130 may be releasably coupled to the first engagement member 122. Upon such coupling, a continuous flow path may be provided to the air from the channel 126 to outside of the filter 100. The first engagement member 122 and the second engagement member 130 may have to withstand pressure due to flow of air and support the coupling engagement between the filter element 124 and the shroud 102. As such, the first engagement member 122 and the second engagement member 130 may be made from materials such as plastic. In an embodiment, the first engagement member 122 and the second engagement member 130 could be beneficially made from bio-degradable type of plastic known to one skilled in the art. Numerous examples of plastics such as, but not limited to, compostable or bio-plastic materials are readily known in the art and may be suitably implemented to form the first and/or second engagement members 122, 130.

The filter element 124 is configured to filter the first air flow 118 received from the inlet 114. The filter element 124 may have any shape such as, but not limited to, cylindrical, rectangular, elliptical, oblong, or any other asymmetrical shapes.

The filter element 124 is formed from one or more bio-degradable materials that are permeable to gaseous fluids. Thus, the filter element 124 may allow air to permeate through the filter element 124 while trapping other foreign particles such as, dirt, dust or other contaminants. In one embodiment, the filter element 124 may be formed from paper having a pleated configuration. In another embodiment, the filter element 124 and the shroud 102 may be formed from different bio-degradable materials.

In methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims.

### INDUSTRIAL APPLICABILITY

The present disclosure has applicability for implementation and use in various industrial settings such as, but not limited to, engines, pneumatics, refineries, power plants; and other applications known to one skilled in the art.

The filter 100 disclosed herein is formed entirely using one or more bio-degradable materials, thereby rendering the filter 100 to be disposable and incinerated. Further, by using low cost materials such as paper and cardboard for producing the filter 100, an overall cost of the filter 100 may be reduced. Additionally, by using the honeycomb matrix of cells 113, the shroud 102 may have improved stiffness to weight ratio thereby improving service life of the filter 100.

In operation, air enters the filter 100 through the inlet 114 to the interior volume 110 of the shroud 102. As air flows over an outer surface 132 of the filter element 124, foreign particles such as dust, dirt are trapped by the filter element 124. The air that is filtered now passes through the channel 126 to the passage 123 of the first engagement member 122 and subsequently out of the filter 100.

Further, as coupling of the filter element 124 to the shroud 102 renders the filter 100 with a unitary construction, the filter 100 may be easily and economically sold as a package or as a single-piece component. Moreover, the filter 100 may be readily implemented for quick fitment onto air inlet systems and/or air filtration systems commonly employed in various applications.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

I claim:

1. A disposable filter for an engine, the filter comprising:
a shroud having at least one pair of sidewalls defining an inlet and an outlet respectively therethrough, wherein each sidewall of the shroud includes:
an outer ply and an inner ply disposed in a spaced-apart relation to each other; and
a core comprising a honeycomb matrix of cells, wherein lateral ends of the core are bonded to inner surfaces of the outer ply and the inner ply to integrally form the sidewall; and
a filter element disposed within the shroud and releasably coupled thereto, wherein the shroud and the filter element are both formed using at least one bio-degradable material.

2. The filter of claim 1, wherein the at least one bio-degradable material is one or more of paper and cardboard.

3. The filter of claim 1, wherein the shroud and the filter element are formed from one of similar and dissimilar bio-degradable materials.

4. The filter of claim 1, wherein one or more of the outer ply and the inner ply are resin-impregnated.

5. The filter of claim 1, wherein the shroud is at least partially coated with a hydrophilic substance.

6. The filter of claim 1, wherein the hydrophilic substance is urethane.

7. The filter of claim 1, wherein the sidewall defining the outlet is further provided with a first engagement member, the first engagement member configured to releasably couple with an inlet of the engine.

8. The filter of claim 7, wherein the filter element is provided with a second engagement member, the second engagement member configured to releasably couple with the first engagement member.

9. The filter of claim 8, wherein one or more of the first and second engagement members is made from a bio-degradable plastic.

10. The filter of claim 1, wherein a shape of the shroud is one of planar, curvilinear, spherical, frusto-conical, conical, and annular.
